(19) United States
(12) Patent Application Publication
(10) Pub. No.: US 2024/0143847 A1
(43) Pub. Date: May 2, 2024

(54) SECURELY ORCHESTRATING CONTAINERS WITHOUT MODIFYING CONTAINERS, RUNTIME, AND PLATFORMS

(71) Applicant: International Business Machines Corporation, Armonk, NY (US)

(72) Inventors: Tatsushi INAGAKI, Yokohama (JP); Yohei UEDA, Shinagawa (JP); Moriyoshi OHARA, Yokohama (JP); Petr NOVOTNY, Mount Kisco, NY (US); James Robert MAGOWAN, Surrey (GB); Martin William John COCKS, Hampshire (GB); Qi Feng HUO, Beijing (CN)

(21) Appl. No.: 18/051,626

(22) Filed: Nov. 1, 2022

(51) Int. Cl. G06F 21/74; G06F 21/53; G06F 21/60; G06F 21/62; H04L 9/32

(52) U.S. Cl. CPC G06F 21/74; G06F 21/53; G06F 21/602; G06F 21/62; H04L 9/3247

(57) ABSTRACT

A method, system, and computer program product are disclosed for securely orchestrating containers in a container orchestration environment. The containers comprise confidential containers running in a trusted execution environment (TEE) and standard containers running in the container orchestration environment. The containers are securely orchestrated without modifying the containers, container runtimes, and platforms, protecting sensitive data and code of the containers by restricting access to containers.

### BACKGROUND

The present invention relates to container orchestration environments and more specifically a method, system and computer program product for securely orchestrating confidential containers in trusted execution environments and standard containers in the same cluster without modifying containers, container runtime, and platforms in a container orchestration environment.

Modern workloads are developed and deployed as containers. In a container orchestration environment, containers do not protect sensitive data and code against a host or cluster administrator. Containers can share resources with the host in available orchestration platforms. Running containers in a trusted execution environment (TEE) can protect containers from the administrators. However, running containers in a TEE forces a change to containers being run. This approach generally requires modifying orchestration platforms, container runtime components, and container images. Development work also must be performed in the TEE running the containers. Requiring container changes or customizing containers to run in a TEE can be labor intensive and time consuming. Standard containers running in the same cluster for orchestration need to be protected from administrators. Current approaches generally fail to prevent the container orchestration administrators from accessing or manipulating a set of containers within a pod once running.

### SUMMARY

According to a disclosed embodiment, a computer-implemented method is provided for securely orchestrating containers in a container orchestration environment. The containers comprise confidential containers running in a trusted execution environment (TEE) and standard containers running in the container orchestration environment. The containers are securely orchestrated without modifying the containers, container runtimes, and platforms. A computer using Secure Container Orchestration (SCO) logic implements features the disclosed embodiments, protecting sensitive data and code of confidential containers and standard containers from administrators.

One non-limiting example computer implemented method comprises providing a Node Agent for managing containers for running application workloads and providing a Secure Agent in a host node of the container orchestration environment in a TEE. The method uses two API decorators comprising a Node Agent Decorator before the Node Agent and a Runtime Decorator after the Node Agent, and a secure agent in a container orchestration environment. Node agent API requests are forwarded to the Node Agent Decorator according to a Network Address Translation (NAT) rule. The Node Agent Decorator multiplexes an aggregated orchestration request per node. The Runtime Decorator multiplexes an orchestration request per container, and the secure agent restricts accesses from the administrators

Other disclosed embodiments include a computer system and computer program product for securely orchestrating containers implementing features of the above-disclosed method.

### BRIEF DESCRIPTION OF THE DRAWINGS

FIG. 1 is a block diagram of an example computer environment for use in conjunction with one or more disclosed embodiments for securely orchestrating containers without modifying containers, container runtime, and platforms;

FIGS. 2 and 3 are block diagrams providing a container orchestration environment and illustrating example operations for securely orchestrating containers of one or more disclosed embodiments; and

FIG. 4 is a flow chart illustrating example operations of securely orchestrating containers of one or more disclosed embodiments.

### DETAILED DESCRIPTION

In accordance with features of embodiments of the disclosure, improved computing system operations are provided for securely orchestrating containers in a container orchestration environment. Improved computing system operations of disclosed embodiments prevent nefarious actors (e.g., rogue administrators) from accessing or manipulating confidential containers running in container pods in a trusted execution environment (TEE) in the container orchestration environment. Improved computing system operations of disclosed embodiments protect sensitive data and code of confidential containers and of standard or Open Container Initiative (OCI) containers, from nefarious actors, and from other client applications, hardware and software components, and the like in the container orchestration environment.

In accordance with features of the disclosed embodiments, two API decorators comprising a Node Agent Decorator before the Node Agent and a Runtime Decorator after the Node Agent, and a secure agent in a container orchestration environment are provided. Node agent API requests are forwarded to the Node Agent Decorator according to a Network Address Translation (NAT) rule. The Node Agent Decorator multiplexes an aggregated orchestration request per node. The Runtime Decorator multiplexes an orchestration request per container, and the secure agent restricts accesses from the rogue administrators. The Secure Agent performs a Trusted Execution Environment (TEE) contract signature verification process and provides access only to users with a signed contract. The multiplexed node agent API requests are sent from the Node Agent Decorator and from the Runtime Decorator to the Secure Agent. The Secure Agent verifies a valid user for the received multiplexed node agent API requests, and only sends the API requests to a Container Runtime and associated container for secure execution when a valid user is identified.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

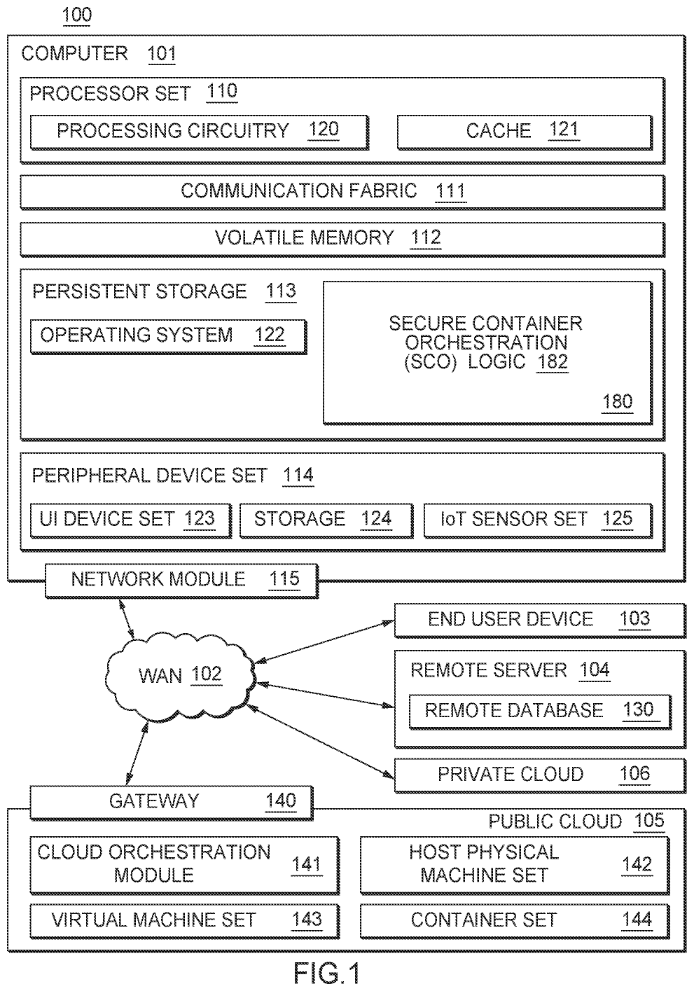

With reference now to FIG. 1, there is shown an example computing environment 100. Computing environment 100 contains an example of an environment for the execution of at least some of the methods at block 180, such as Secure Container Orchestration (SCO) logic 182. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In accordance with a disclosed embodiment, a computer-implemented method securely orchestrates containers in a container orchestration environment. The containers comprise confidential containers in a trusted execution environment (TEE) and standard containers within a node. The containers are securely orchestrated without modifying the containers, container runtimes, and platforms in accordance with a disclosed embodiment. A computer, using Secure Container Orchestration (SCO) logic implements the disclosed method, protecting sensitive data and code of confidential containers and of standard or Open Container Initiative (OCI) containers from administrators. The method comprising providing two API decorators associated with a Node Agent. The API decorators comprise a Node Agent Decorator in front of a Node Agent, and a Runtime Decorator in back of the Node Agent; providing a secure agent in the container orchestration environment, and forwarding node agent API requests to the Node Agent Decorator according to a Network Address Translation (NAT) rule. The Node Agent Decorator multiplexes an aggregated orchestration request per controller node. The Runtime Decorator multiplexes an orchestration request per container, and the secure agent restricts accesses from the administrators.

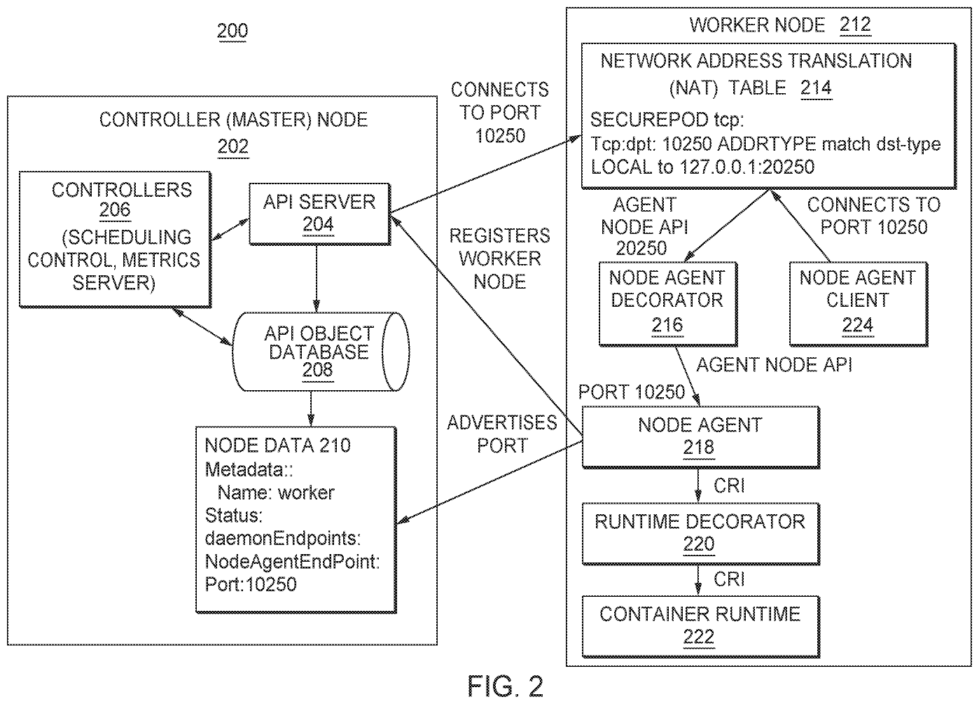

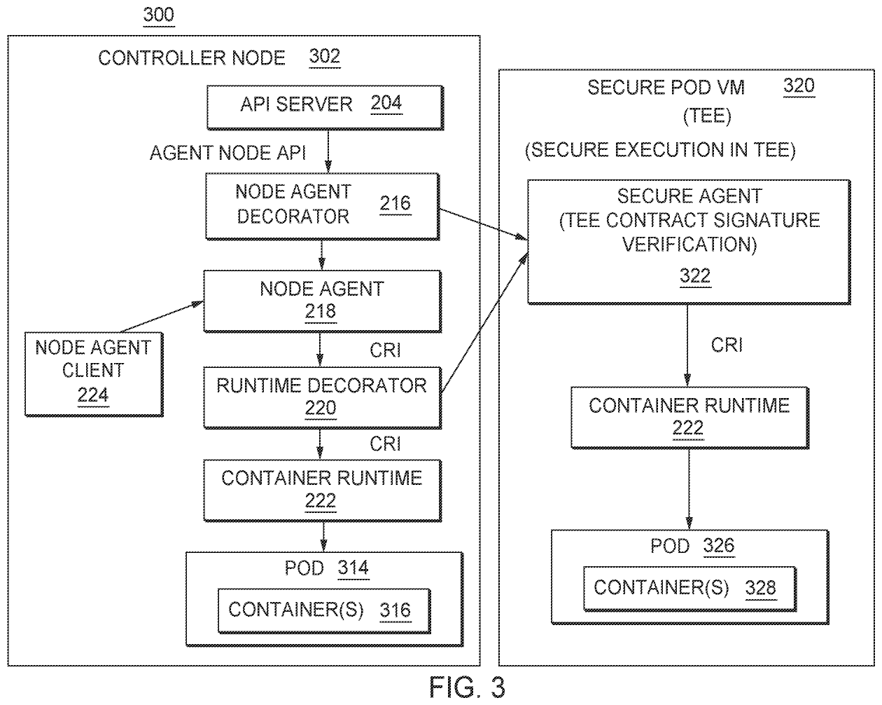

FIGS. 2 and 3 are block diagrams illustrating a respective container orchestration environment 200 and 300 including example operations for securely orchestrating containers of one or more disclosed embodiments in the combined container orchestration environments 200, 300. Computing environment 100 is used in conjunction with the combined container orchestration environments 200, 300 to implement features of disclosed embodiments and securely orchestrate containers without modifying containers, container runtimes, and platforms. The combined container orchestration environments 200, 300 can be implemented with various currently available container orchestration environments, such offered by various cloud service providers. For example, a container orchestration environment such as Kubernetes could be used that provides a platform for automating deployment, scaling, and operations of application containers across clusters of host nodes. Kubernetes® is a registered trademark of the Linux Foundation of San Francisco, California.

With reference now to FIG. 2, container orchestration environment 200 includes a controller node 202, such as a primary node 202. Controller node 202 is a controlling unit of a cluster of host nodes, for example, managing the cluster's workload, and directing communication across the cluster. Controller node 202 includes various components, such as shown comprising an application programming interface (API) server 204, controllers 206, and an API object database 208 coupled to Node data 210.

API server 204 operates with a plurality of controllers 206 including a scheduler and controller metric server that collect and aggregate cluster-wide resource usage data. For example, the controller 206 (e.g., a Metric Server) collects resource metrics for a Node Agent running on each worker node, such as an illustrated worker node 212, and exposes the resource metrics to the API server 204 through metrics API.

API object database 208 is a distributed key-value data store used to hold and manage critical information needed to keep distributed orchestration nodes and container running. The API object database 208 manages and stores configuration data, state data, and metadata of the distributed container orchestration platform, such as Kubernetes of the container orchestration environment 200, representing the overall and desired healthy state of the cluster at any given time. Node Data 210 stores configuration data, state data, and metadata such as shown for the worker node 212 including name, status, endpoints, and port number.

The API server 204 provides internal and external interfaces for the controller node 202, such as an API request to connect to the worker node 212 as indicated at the line labeled CONNECTS TO PORT 10250, where the port 10250 is the port number for the worker as shown in Node Data 210. The API server 204 processes and validates resource availability requests and updates state of API objects in the data store, thereby allowing users (e.g., clients, customers, or the like) to configure workloads and containers across host nodes in the cluster. API server 204 together with scheduler control 206 selects, which host node, an unscheduled pod runs on, based on resource availability of respective host nodes.

The scheduler controller 206 tracks resource utilization on each host node of the container orchestration environment to ensure that workload is not scheduled in excess of available resources. The scheduler control 206 communicates with the API server to create, update, and delete the resources the controller manages (e.g., pods, service endpoints, and the like).

Worker node 212 includes a Network Address Translation (NAT) Table 214, a Node Agent Decorator 216, a Node Agent 218, a Runtime Decorator 220 and a container runtime 222. NAT Table 214 stores identifying information for clients or users and uses a NAT rule to forward API requests from API server 204 and from a Node Agent client 224 to the Node Agent Decorator 216 in front of the Node Agent 218 of the worker node 212 for valid users.

The Node Agent Decorator 216 multiplexes an aggregated orchestration request per node, such as worker node 212. The Node Agent Decorator 216 applies the multiplexed aggregated orchestration request to the Node Agent 218 in accordance with the disclosed embodiments. In one embodiment, the Node Agent 218 applies a Container Runtime Interface (CRI) command of the multiplexed aggregated orchestration request per controller node to Runtime Decorator 220. The Runtime Decorator 220 multiplexes an orchestration request per container, and applies the multiplexed CRI request per container to the container runtime 222 of worker node 212, as shown.

As shown, the API server 204 provides an API request to NAT 214 of the worker node 212 as indicated at line labeled CONNECTS TO PORT 10250 for the worker. Similarly, the Node Agent client 224 provides an API request to NAT 214 as indicated at line also labeled CONNECTS TO 10250. NAT 214 forwards identified valid requests to the Node Agent Decorator 216 as indicated by 20250, corresponding to the translated PORT 10250 for the Node Agent Decorator 216. The Node Agent Decorator 216 multiplexes an aggregated orchestration request per controller node 202 for API server requests and sends the multiplexed aggregated request to the Node Agent 218, as indicated at line labeled AGENT NODE API. The Node Agent 218 also advertises the port when it registers the worker as indicated at line ADVERTISES PORT connected to Node Data 210 of the controller node 202. The Runtime Decorator 220 multiplexes an orchestration request per container for the CRI request received from the Node Agent 218 and sends the multiplexed CRI request to the container runtime 222.

With reference also to FIG. 3, the illustrated container orchestration environment 300 includes a controller node 302, together with a secure pod Virtual Machine (VM) 320. The controller node 202 and controller node 302 are host nodes, for example, that is a machine, physical or virtual, where containers (i.e., application workloads) are deployed. In the container orchestration environment 300, the controller node 302 comprises an API server 204, a Node Agent Decorator 216, a Node Agent 218 (e.g., a kubelet in the Kubernetes platform), a Runtime Decorator 220, a container runtime 222, and a pod 314. The pod 314 includes a group of one or more containers 316.

The host node or controller node 302 hosts pods, such as pod 314 and containers 316 that are the components of the application workloads. A container orchestration environment typically includes multiple controller nodes for high availability, such as controller nodes 202, 302, each hosting container pods and containers. The Node Agent 218 is an agent that runs on each host node, such as controller node 302, and is responsible for the running state of each host node and ensures that all containers of a container orchestration environment, such as container 316 on the controller node 302 are running and healthy. The Node Agent 218 manages the containers 316 organized into pods 314. The container runtime 222 holds the running application, libraries, and their dependencies of a service hosted by the container orchestration environments 200, 300.

In accordance with the disclosed embodiments, the Node Agent Decorator 216 multiplexes an aggregated orchestration request per controller node 302. The Runtime Decorator 220 receives CRI commands from the Node Agent 218. The Runtime Decorator 220 multiplexes an orchestration request per container and applies the multiplexed CRI requests to Container Runtime 222 coupled to the container 316 of pod 314.

The secure pod Virtual Machine (VM) 320 of container orchestration environment 300 provides a Trusted Execution Environment (TEE), enabling secure execution of containers. The secure pod VM 320 includes a Secure Agent 322, a Container Runtime 222, and a pod 326 that includes a set of one or more containers 328.

In accordance with the disclosed embodiments, the Secure Agent 322 implements a TEE contract signature verification process that is used to restrict access to containers in the secure pod VM 320 only to identified users with a signed contract. The Secure Agent 322 performs the TEE contract signature verification process, for example verifying a matching or valid signature in a signed TEE contract for users, and otherwise prevent accesses to containers when a user is not verified. For an identified valid user, Secure Agent 322 provides a CRI command to a Container Runtime 222 that is coupled to container 328 in pod 326 in the secure pod VM 320.

The Secure Agent 322 is installed with installation of the secure pod VM 320 in the container orchestration environment 300 and the Node Agent Decorator 216 and Runtime Decorator 220 similarly are installed in the worker node 212 and the controller node 302 in the combined container orchestration environments 200, 300 in FIGS. 2 and 3. The installed Secure Agent 322, Node Agent Decorator 216 and Runtime Decorator 220 enable container orchestration operations at runtime.

In accordance with the disclosed embodiments, the multiplexed CRI requests for respective Decorators 216 and 220 are forwarded to the Secure Agent 322 in the secure pod VM 320 for secure execution of pod containers 328. The Node Agent Decorator 216 applies the multiplexed CRI commands to the Secure Agent 322. The Runtime Decorator 220 applies the multiplexed CRI commands to the Secure Agent 322. The Secure Agent 322 applies the multiplexed CRI commands to Container Runtime 222 for an identified valid user. Container Runtime 222 routes the CRI command traffic for secure execution in the container 328 in pod 326. The Secure Agent 322 prevents access to the confidential container 328 in pod 326 unless a valid user is identified for the received multiplexed CRI commands.

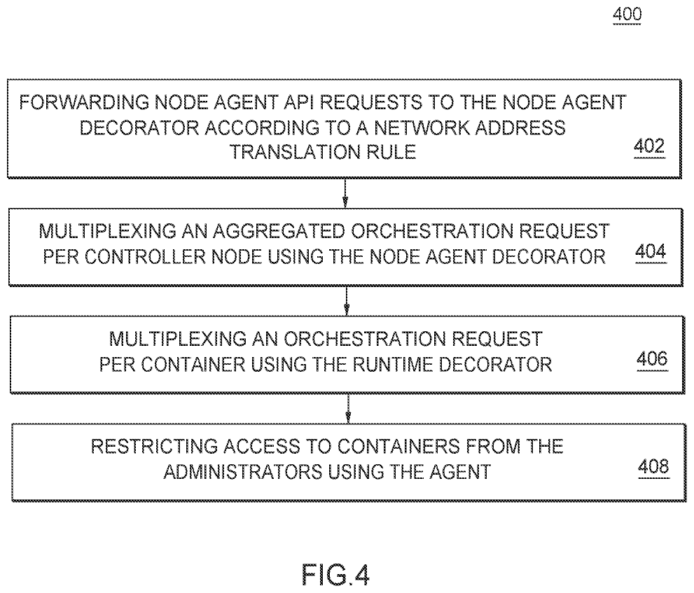

In accordance with disclosed embodiments, FIG. 4 illustrates example operations of a computer-implemented method 400 for securely orchestrating both confidential containers in trusted execution environments and standard containers in the same cluster, to protect sensitive data and code of the containers from nefarious actors (e.g., rogue administrators). In one embodiment, the computer-implemented method 400 securely orchestrates the containers without modifying containers, container runtimes, and platforms in the combined container orchestration environments 200, 300 in FIGS. 2 and 3. Method 400 may be implemented with computer 101 for example, Secure Container Orchestration (SCO) logic 182 provides an example computer control for operations performed by the referenced software or firmware objects of method 400 of the disclosed embodiments.

Referring to FIG. 4 at block 402, for an identified valid user, the API server forwards node agent API requests to the Node Agent Decorator 216 of the associated Node Agent 218. For example, API requests are forwarded to the Node Agent Decorator 216 of the associated Node Agent 218 identified by the Network Address Translation (NAT) Table 214 as shown in FIG. 2.

At block 404, the Node Agent Decorator 216 multiplexes an aggregated orchestration request for a controller node. For example, the Node Agent Decorator 216 of the Node Agent 218 multiplexes the aggregated orchestration request per controller node, such as shown in FIGS. 2 and 3.

At block 406, the Runtime Decorator 310 multiplexes an orchestration request per container. For example, as shown in FIGS. 2 and 3 the Runtime Decorator 220 receives CRI requests from the Node Agent 218 and multiplexes the orchestration request per container associated with Node Agent 218, such as containers 316 and 328.

At block 408, the secure agent 322 restricts accesses from the administrators so that any rogue administrators cannot access the pods 326 and the containers 328. For example, as shown in FIG. 3 the secure agent 322 receives and validates multiplexed API requests from the Node Agent Decorator 216 and Runtime Decorator 220, for example, performing TEE contract signature verification before sending to the Container Runtime 222 coupled to the associated container 328. Otherwise, when the user is not validated by the TEE contract signature verification process, the secure agent 322 restricts access to the associated container and the multiplexed API requests are not sent to the Container Runtime 222 and associated container 328. The secure agent 322 enables access to validated users and prevents access to others including administrators in accordance with the disclosed embodiments.

While the foregoing is directed to embodiments of the present invention, other and further embodiments of the invention may be devised without departing from the basic scope thereof, and the scope thereof is determined by the claims that follow.

What is claimed is:

1. A computer-implemented method for securely orchestrating containers in a container orchestration environment, the method comprising:
providing a Node Agent for managing containers for running application workloads and a Secure Agent in a controller node of the container orchestration environment;
using two API decorators comprising a Node Agent Decorator before the Node Agent, and a Runtime Decorator after the Node Agent;
forwarding node agent API requests to the Node Agent Decorator;
multiplexing, at the Node Agent Decorator, an aggregated orchestration request for the controller node;
multiplexing, at the Runtime Decorator an orchestration request for an associated container; and
restricting accesses to the containers using the Secure Agent.

2. The method of claim 1, wherein the containers comprise confidential containers running in a trusted execution environment (TEE) and standard containers running in a cluster in the container orchestration environment.

3. The method of claim 2 further comprising using the Secure Agent to protect sensitive data and code of the containers, restricting access to containers without modifying containers, container runtimes, and platforms in the container orchestration environment.

4. The method of claim 2, wherein the containers comprise unmodified confidential containers and the standard containers running in a cluster comprise Open Container Initiative (OCI) containers.

5. The method of claim 1, wherein the Secure Agent uses a Trusted Execution Environment (TEE) contract signature verification process to provide access only to users with a signed contract.

6. The method of claim 1, wherein the multiplexed node agent API requests are sent from the Node Agent Decorator and from the Runtime Decorator to the Secure Agent.

7. The method of claim 6, wherein the Secure Agent uses a Trusted Execution Environment (TEE) contract signature verification process to verify a valid user for the received multiplexed node agent API requests.

8. The method of claim 7, wherein the Secure Agent sends node agent API requests to a Container Runtime and associated container for secure execution responsive to verifying a valid user for the received multiplexed node agent API requests.

9. The method of claim 1, wherein forwarding node agent API requests to the Node Agent Decorator comprises using a Network Address Translation (NAT) Table for identifying valid clients of the container orchestration environment.

10. The method of claim 1, further comprising a computer using Secure Container Orchestration (SCO) logic to implement operations to securely orchestrate containers in the container orchestration environment.

11. A system, comprising:
a processor; and
a memory, wherein the memory includes a computer program product configured to perform operations for secure orchestration of containers in a container orchestration environment, the operations comprising:
providing a Node Agent for managing containers for running application workloads and providing a Secure Agent in a controller node of the container orchestration environment;
using two API decorators comprising a Node Agent Decorator before the Node Agent, and a Runtime Decorator after the Node Agent;
forwarding node agent API requests to the Node Agent Decorator multiplexing, at the Node Agent Decorator an aggregated orchestration request for the controller node,
multiplexing, at the Runtime Decorator an orchestration request for an associated container, and
restricting accesses to the containers using the Secure Agent.

12. The system of claim 11, wherein the operations further comprise:
using the Secure Agent to protect sensitive data and code of the containers, preventing access to containers by administrators without modifying containers, container runtimes, and platforms in the container orchestration environment.

13. The system of claim 11, wherein forwarding node agent API requests to the Node Agent Decorator comprises using a Network Address Translation (NAT) Table for identifying valid clients of the container orchestration environment.

14. The system of claim 11, wherein the operations further comprise sending multiplexed node agent API requests from the Node Agent Decorator and from the Runtime Decorator to the Secure Agent.

15. The system of claim 14, wherein the Secure Agent uses a Trusted Execution Environment (TEE) contract signature verification process to verify a valid user for the received multiplexed node agent API requests.

16. A computer program product for securely orchestrating containers in a container orchestration environment, the computer program product comprising:
a computer-readable storage medium having computer-readable program code embodied therewith, the computer-readable program code executable by one or more computer processors to perform an operation comprising:
providing a Node Agent for managing containers for running application workloads and providing a Secure Agent in a controller node of the container orchestration environment;
using two API decorators comprising a Node Agent Decorator before the Node Agent, and a Runtime Decorator after the Node Agent;
forwarding node agent API requests to the Node Agent Decorator;
multiplexing, the Node Agent Decorator an aggregated orchestration request for the controller node,
multiplexing, at the Runtime Decorator an orchestration request for an associated container, and
restricting access to the containers using the Secure Agent.

17. The computer program product of claim 16, wherein the Secure Agent performs a Trusted Execution Environment (TEE) contract signature verification process and provides access only to users with a signed contract.

18. The computer program product of claim 16, wherein forwarding node agent API requests to the Node Agent Decorator comprising using a Network Address Translation (NAT) Table for identifying valid clients of the container orchestration environment.

19. The computer program product of claim 16, wherein the operation further comprises sending multiplexed node agent API requests from the Node Agent Decorator and from the Runtime Decorator to the Secure Agent.

20. The computer program product of claim 19, wherein the operation further comprises responsive to the Secure Agent verifying a valid user for the received multiplexed node agent API requests, the Secure Agent sending node agent API requests to a Container Runtime and associated container for secure execution.
